(19) United States
(12) Patent Application Publication
(10) Pub. No.: US 2019/0050587 A1
(43) Pub. Date: Feb. 14, 2019

(54) GENERATING ELECTRONIC AGREEMENTS WITH MULTIPLE CONTRIBUTORS

(71) Applicant: ADOBE SYSTEMS INCORPORATED, San Jose, CA (US)

(72) Inventors: Nikhil Dang, New Delhi (IN); Anupam Chaturvedi, Noida (IN); Palash Jain, Dhar (IN); Aastha Garg, Ghaziabad (IN); Damanjyot Talwar, Farudabad (IN); Harish Kumar Yadav, Noida (IN)

(21) Appl. No.: 15/672,172

(22) Filed: Aug. 8, 2017

(51) Int. Cl. G06F 21/62; G06F 21/60; G06F 17/30; G06Q 10/06

(52) U.S. Cl. CPC G06F 21/6209; G06Q 10/06; G06F 17/30171; G06F 21/604

(57) ABSTRACT

An electronic signature system includes infrastructure for securely managing document preparation during signing workflows through the assignment of permissions to users that control user actions to add, remove, and/or edit documents in a document package as part of an electronic signing workflow. The permissions may be assigned based on roles given to each user, and used to manage the signing workflow and user accesses to the document package. The electronic signature system determines whether to authorize the contributors to add, remove, and/or edit documents during the workflow according to the assigned permissions of each user. Document metadata is captured that identifies users and/or user groups associated user actions on particular documents. Access to those documents may be restricted using the document metadata. Once the document package is prepared, the document package is provided to a signer for review and for an electronic signature of documents of the document package.

### BACKGROUND

Organizations may have many employees, divided amongst departments, with different levels and areas of expertise and different responsibilities. Therefore, there may be many people involved in preparing documents for signature. Once the documents are prepared without the aid of an electronic signature system, a conventional electronic signature system may then be used to manage and track the signing process in a secure and legally enforceable manner. In doing so, an originator account of a signing workflow is used that provides all of the prepared documents to the system that are ready to be signed by other users and initiates the workflow. Once initiated, no other user can add to or remove from the documents provided by the originator. However, some users may view any of the documents to ensure they were prepared correctly, and may modify form fields to correct any errors.

As all of the documents are provided upfront by a single user, and are intended to be ready for signature, conventional electronic signature systems lack infrastructure to track and manage the document preparation process in a secure and efficient manner. For example, if an organization desired to use a conventional electronic signature system for document preparation, everyone would need to share access to the originator account. However, the system would provide everyone with unrestricted access to all files, introducing security risks and inefficiencies. For example, the system would be incapable of preventing certain people from viewing sensitive information or modifying documents they should not modify. Further, each person could access the documents anytime with no tracking or auditing of the order in which they are accessed or in which changes are made. Additionally, any changes to the documents would be anonymous as the system has no way to determine who made a particular change.

### SUMMARY

The present disclose provides, in part, electronic signature systems with infrastructure for securely managing document preparation during signing workflows through the assignment of permissions to users. This can be facilitated using a permissions model in which permissions can be assigned to define capabilities of non-signer users to alter a set of documents of a document package during a signing workflow.

In various respects, the electronic signature system assigns permissions to users to define the users' abilities to alter documents of a document package during the signing workflow. Permissions may be assigned to users using predefined roles, and some permissions can be individually assigned. The electronic signature system uses the permissions assigned to a user to determine whether to authorize user actions to add a document to or remove a document from the set of documents of the document package being prepared in the signing workflow, or otherwise modify document content and metadata. These permissions may define access rights for particular documents, rather than all documents. In further respects, the electronic signature system can assign users to user groups that are used to manage the signing workflow. User groups can be used to define user access rights at particular times during the signing workflow, as well as to set conditions for advancing the signing workflow. For example, access could be limited to members of particular user groups and/or conditions for advancing the workflow may depend upon a member of a particular user group accessing the document package, rather than a particular user.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1A is a block diagram of an exemplary system architecture in which some embodiments of the invention may be employed;

FIG. 1B is a block diagram of an exemplary electronic signature system in accordance with some embodiments of the invention;

FIG. 2 is a flow diagram that illustrates a method for a signing workflow in accordance with some embodiments of the invention;

FIG. 3A is an illustration of an exemplary view in a user interface in accordance with some embodiments of the invention;

FIG. 3B is an illustration of an exemplary view in a user interface in accordance with some embodiments of the invention;

FIG. 4 is an illustration of an exemplary view in a user interface in accordance with some embodiments of the invention;

FIG. 5 is a flow diagram that illustrates a method for a signing workflow in accordance with some embodiments of the invention; and

FIG. 6 is a block diagram of an exemplary computing environment suitable for use in implementing embodiments of the present invention.

### DETAILED DESCRIPTION

Various terms used throughout are described below:

A “user” refers to a particular digital identify that interacts with an electronic signature system. The user can be tracked and maintained in the electronic signature system in the form of a user profile containing information the system uses to associate user inputs, user actions, permissions, user groups, authorizations, and other information to that user. Terms such as user input and user action are not intended to necessarily correspond to a particular user. Typically, the user profile includes a user identifier, such a login and password and/or email address the system uses to identify a user. A “user action” refers to at least one operation performed by the system at the direction of user input.

“Signing” and “signature” refer to any one of a variety of methods of electronically affixing an indication of assent to a document. Electronically signing a document entails virtually affixing an indication of assent to the electronic document through an electronic interface. Examples of interfaces that can be used to affix such an indication of assent include, but are not limited to, a touchscreen interface, a gesture interface, a voice recognition interface, and a facial recognition interface.

A “document package” refers to an electronic container for a set of documents (i.e., at least one document) to be signed in a signing workflow. After preparation of the set of documents is complete, the document package is provided for signature (e.g., to at least one designated signer of the signing workflow). A document package may or may not include a document at the initiation of a signing workflow, but when prepared and provided for signature, includes at least one document that is digitally transmitted for signature. The documents of a document package are electronic documents that are digitally assigned to a particular document package.

A “signing workflow,” or “electronic signing workflow,” refers to a digital process whereby an electronic signature system manages the procurement of at least one signature to at least one document. A signing workflow includes a sequence of logical steps that define the workflow and conditions for advancing to a subsequent logical step. A condition for each logical step requires the system to receive a user action from at least one user in order to be satisfied. Examples of logical steps include a step in which the system initiates a signing workflow, a step in which the system authorizes a user action removing a document from and/or adding a document to a document package during the signing workflow, and a step in which the system receives an electronic signature for the document. A signing workflow typically includes a step in which the system receives a signature from a user, and that signature is stored and maintained by the system in a legally enforceable and secure manner.

An electronic signing workflow may be defined in terms of workflow events. Any number of workflow events could be assigned to a particular step of a signing workflow to define the workflow. A workflow event can correspond to a particular system or user action, such as user actions, for example, to manipulate and edit documents of a document package. A workflow event status indicator may be assigned to each workflow event. Prior to reaching a corresponding step in the workflow, the system may assign a status value of “pending” to a workflow event. As a workflow event begins, the corresponding workflow event status value may be updated to “in progress.” When the system determined a workflow event is successfully completed, the workflow event status value may be updated to “completed.” A workflow engine may uses these status indicators to determine whether to advance the workflow and to track the current state of the workflow. In this way, the electronic signing workflow can control the order in which document contributors and signers gain access to the document package.

A “participant” refers to any user associated with an electronic signing workflow. For example, an originator of a signing workflow may provide an association between a user and the electronic signing workflow by assigning that user to the workflow and/or document package. Participants may be, for example, originators, contributors, or signers. An “originator” refers to a user that initially defines a document package for a signing workflow. A “document contributor,” “contributing user,” or “contributor” refers to a user that provides at least one document to and/or edits at least document of a document package during a signing workflow. A “signer” refers to a user that signs at least one document of a document package. Contributors and signers may be defined by an originator of a signing workflow. A “non-signer” user refers to a user that in not a signer in a signing workflow.

A “permission” refers to a predefined authorization rule that can be assigned to a user that enables the user to access specific resources of the system, such as documents of a document package and/or associated metadata. A permission may be used by the system to determine which user actions are authorized prior to executing and/or persisting those actions. Examples of permissions include, a permission to display documents in the document package, add or remove documents from a document package, edit existing documents in a document package, add, remove, or edit form fields or content of an existing document, and more. Permissions may be defined on the system, at least partially by roles.

A “role” refers to a predetermined grouping of permissions defined by the system. A role includes at least one default permission, and different roles are distinguished by the groups of permissions associated with that role.

A “user group” refers to a grouping of users that is defined by a user, such as an originator, and saved by the system for use in managing a signing workflow. A user assigned to a particular user group is considered a member of that group. Examples of user groups include a legal group, a finance group, a human resources group, and the like. Each user group could have a user provided tag, or name, and user groups could be saved for use in multiple signing workflows. Users may belong to none, one, or many groups.

Many people may be involved in preparing documents for signature. Conventional electronic systems are used to manage the acquisition of signatures for prepared documents, and in many respects, lack capabilities for securely preparing the documents that will be signed. Once a signature workflow is initiated, no other user can add to or remove from the documents provided by an originator. However, some users may be given unrestricted access to the documents for review to ensure they were prepared correctly, and possibly to correct any errors made to form fields. If an organization desired to use a conventional system for document preparation, everyone could share access to the originator account. However, the system would provide everyone with unrestricted access to all files, introducing security risks and inefficiencies. For example, the system would be incapable of preventing certain people from viewing sensitive information or modifying documents they should not modify. Further, each person could access the documents anytime with no structure to the order in which they are accessed. Additionally, any changes to the documents would be anonymous as the system has no way to determine who made a particular change.

The present disclosure addresses the technological shortcomings associated with existing electronic signature system by providing, in part, an improved electronic signature system with infrastructure for securely and efficiently managing document preparation during signing workflows. In various implementations, the electronic signature system assigns various permissions to appropriate users based on input received from an originator of the signing workflow or other user. The electronic signature system uses these permissions to integrate document preparation into the signing workflow. For example, the electronic signature system provides a user interface (UI) and/or application program interface (API) for receiving user input to assign permissions for the signing workflow. These assignments can be stored in a data store, where they are accessible to the electronic signature system to determine user access rights and authorize user actions during the signing workflow.

Using this approach, the electronic signature system is able to authorize user access to a document package for altering documents, and those rights can be tailored to particular users. Therefore, certain users may be restricted from certain user actions, enhancing the security of the system. Security if further enhanced as the system can track and log various user actions involved in document preparation with respect to many different users, as opposed to a single originator account.

The permissions assigned to a user are used by the electronic signature system to authorize user actions during the signature workflow including adding a document to or removing a document from the set of documents of the document package being prepared in the signing workflow, or otherwise modifying document content and metadata. In some implementations, a permission is assigned by assigning a predefined role associated with the permission to a user. For example, the electronic signature system may support a number of predefined roles, each role having a different default set of permissions that are assigned to users with that role. Different roles may offer different permission sets for altering a set of documents included in a document package during a signing workflow.

In addition, or instead, some permissions can be individually assigned to particular users. In some cases, a set of individually assignable permissions for a particular user is defined by a role assigned to that user. For example, permissions for an “Author” role may not authorize user actions to edit form fields of documents, whereas permissions for a “Co-Author” may authorize user actions to edit form fields and more specific variations to that capability (e.g., the ability to edit form fields added by other users in addition to their own).

In further respects, the disclosure provides electronic signature systems with capabilities to assign and enforce permissions on document packages at the document-level, such that the electronic signature systems can provide users with different access rights to particular documents during the signing workflow. These permissions may define access rights for particular documents. In various implementations, the system can track and store document metadata that records user actions to the document package with respect to particular users and/or user groups and particular documents. This information may then be accessed by the electronic signature system to determine user accesses rights to particular documents during the signing workflow. In contrast, conventional systems are incapable of tracking and recording document metadata to identify various users or user groups involved with preparation of particular documents. These conventional systems must provide users with either unrestricted access to all documents, or deny access to all documents.

In further respects, the disclosure provides electronic signature systems with capabilities to assign user groups to users and use those user groups to manage signing workflows. For example, users can be assigned to particular user groups (e.g., based on input from the originator) that are used to manage a signing workflow. In some cases, user group membership defines at least some of a particular user's access rights (e.g., with respect to particular documents). For example, the electronic signature system may authorize only users in a particular user group to remove, edit, and/or view documents associated with that user group so long as those users have the appropriate permissions.

Additionally, user groups can be used to define user access rights at particular times during the signing workflow, as well as to set conditions for advancing the signing workflow. For example, the electronic signature system could limit access to members of particular user groups, and/or conditions for advancing the workflow may depend upon a member of a particular user group accessing the document package, rather than a particular user. As an example, rather than a condition for advancing the workflow requiring action from a particular user, the system can determine the condition is satisfied based on user group membership of an accessing user, such that any member could cause a condition to be satisfied. This can avoid situations where the system is unable to advance the workflow because of inaction by a specific user. Further, using user groups, the electronic signature system can manage user actions for different users (e.g., from different user groups) accessing a document package in parallel without requiring a specific sequence of user accesses.

Accordingly, embodiments of the present disclosure provide for improvements to electronic signature systems to address technical problems of existing electronic signatures systems related to document preparation as well as securely and effectively managing signing workflows.

In various implementations, the electronic signature system can provides access to the document package and authorizations to user actions with respect to the document package to users according to the sets of permissions assigned to those users. User group membership, the current step or stage of the signing workflow, as well as document metadata can be used to further restrict the access and authorizations. For example, while a user has a permission to remove documents, the permission may be restricted to documents the user had previously added (or other member of a particular user group) to the document package using document metadata, which captures that user action.

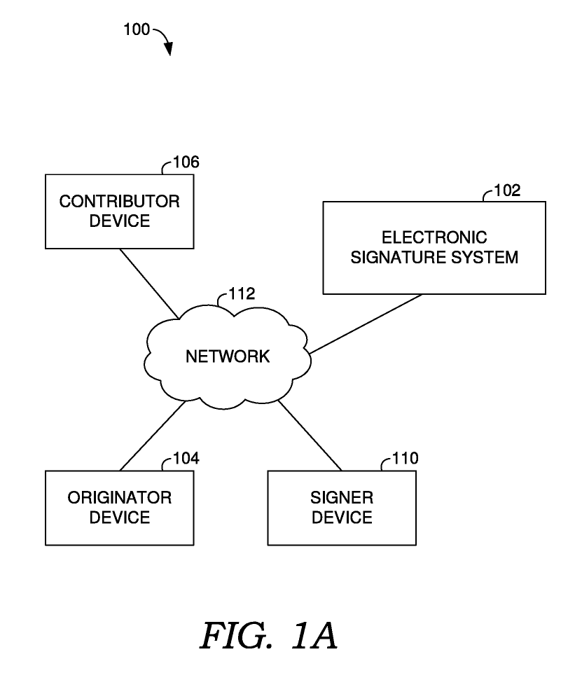

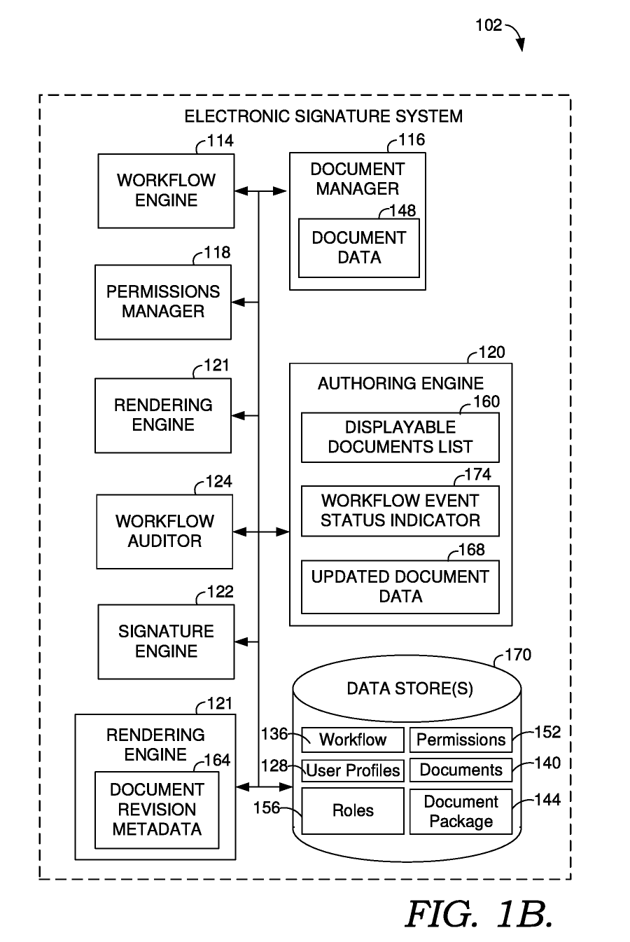

Turning now to FIG. 1A, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, system 100 includes an electronic signature system 102 and a number of client devices, such as originator device 104, contributor device 106, and signer device 110. It should be understood that system 100 shown in FIG. 1A is an example of one suitable computing system architecture. For example, any number of contributor devices, originator devices, and signer devices could be employed.

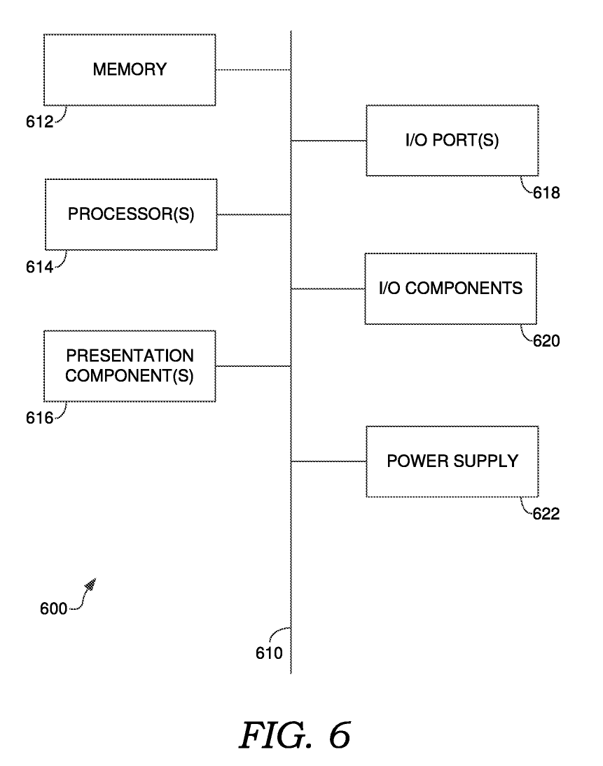

Each of the components shown in FIG. 1A may be implemented via any type of computing device, such as computing device 600 described with reference to FIG. 6, for example. The components may communicate with each other via network 112, which may include, without limitation, one or more local area networks (LANs) and/or wide area networks (WANs). Such networking environments are commonplace in offices, enterprise-wide computer networks, intranets, and the Internet. It should be understood that any number of devices may be employed with system 100 within the scope of the present invention. Each may comprise a single device or multiple devices cooperating in a distributed environment. For instance, the functionality of electronic signature system 102, as described herein, could be provided by a single server device or by multiple server devices operating collectively. Additionally, other components not shown may also be included within the network environment.

System 100 illustrates a computing environment in which electronic signature system 102 may facilitate a signing workflow to obtain an electronic signature for a document package. It is noted that in FIG. 1A, contributor device 106, originator device 104, and signer device 110 are named after participants associated with the signing workflow that use those devices to interact with electronic signature system 102, for ease of explanation. However, any number of client devices and roles could be employed to facilitate the signing workflow. Further, a single user could use multiple devices at different times in a signing workflow.

Generally, electronic signature system 102 initiates the signature workflow in response to receiving input from an originator of a signing workflow via an originator device 104. This can include user input from the originator that is used to generate the document package and/or information that electronic signature system 102 uses during the signing workflow. For example, electronic signature system 102 can optionally receive at least one initial document from the originator device 104 to include in the set of documents of the document package. Furthermore, electronic signature system 102 can receive, from the originator via the originator device 104, an indication of users as participants of the signing workflow, such as email addresses of those users. These users may include at least one contributor and/or signer.

Additionally, electronic signature system 102 can assign at least one permission to participants of the signing workflow based on input received from the originator via the originator device 104. As will be described in further detail below, these assigned permissions can be used by electronic signature system 102 to securely manage document preparation during the signing workflow. For example, permissions can be assigned to define capabilities of particular users (e.g., contributors) to alter a set of documents of a document package during the signing workflow. In some approaches, a permission is assigned by assigning a predefined role associated with the permission to a user. In addition or instead, permissions can be individually assigned to particular users.

The permissions assigned to a user may define the user's ability to add a document to, remove a document from, and/or modify or view a document in the set of documents of the signing workflow. As will be described in additional detail below, electronic signature system 102 can enforce permissions on document packages at the document-level, such that users may have different access rights to particular documents during the signing workflow. For example, permissions assigned to a user (e.g., by the originator) can define the user's ability to display or view a document, remove a document, or add, edit, and/or remove form fields from a document (or otherwise modify the content of a document).

As another example, a user (e.g., originator) may provide user input assigning a permission to a non-signer user that enables the non-signer user to add at least one other non-signer user to the signing workflow. This addition could be performed by the non-signer user during the signing workflow. Furthermore, at least some of the permissions assigned to additional non-signer users may, for example, be based on the permissions assigned to the original non-signer user. In some cases, one or more of these permissions are automatically assigned. Further, one or more of these permissions may be individually assigned by the original non-signer user. To illustrate the forgoing, a non-signer user that is a human resources (HR) manager might add a non-signer user that is a finance manager to provide stock details for an offer letter. In doing so, the HR manager could assign permissions that limit access of the finance manager to one or more particular documents or portions thereof, and/or provide the ability to add documents, but not remove documents. The finance manager in turn might add another non-signer user from a legal team that enables that user to add documents that need to be signed as a part of accepting the stocks set forth in the document(s) added by the HR manager.

Electronic signature system 102 is also capable of managing users and enforcing permissions at a group-level. For example, electronic signature system 102 can assign users to particular user groups (e.g., based on input received from the originator via the originator device 104) that are used to manage the signing workflow. Assigning a user to a user group may define at least some of the particular user's permissions (e.g., with respect to particular documents). As an example, only users in a particular user group might be authorized by electronic signature system 102 to remove, edit, and/or view documents associated with that user group.

Once electronic signature system 102 has received input specifying the various information for the signing workflow, electronic signature system 102 can initiate the signing workflow. This could include electronic signature system 102 initiating the signing workflow in response to the originator providing an explicit command to initiate the workflow, such as via a selectable button. Electronic signature system 102 can use the information from the originator to generate the document package and/or manage the signing workflow. For example, electronic signature system 102 can use the user identity, user group, role, and/or permission assignments to determine user access rights and authorize access the document package during the signing workflow. This could include rights to display and/or edit the document package and/or contents thereof (e.g., the set of documents) according to each user's assigned permissions.

For example, electronic signature system 102 could provide access to a user via one contributor device 106, and electronic signature system 102 could provide access to another user via another contributor device 106. In doing so, electronic signature system 102 can access a set of permissions associated with each user in order to authorize corresponding user actions and manage the signing workflow. It should be understood that any number of users and associated contributor devices could be employed in a signing workflow.

In some implementations, electronic signature system 102 may maintain and enforce a specific order, or sequence, with which electronic signature system 102 grants particular users access to the document package or authorizes particular actions or types of access. The order may be based on the roles defined for each user profile and/or explicitly specified by an originator of the signing workflow (e.g., prior to initiating the workflow). A typical sequence of a signing workflow may start with an originator, followed by at least one contributor, followed by at least one signer.

Electronic signature system 102 can in some implementations log workflow events, such as with respect to each user and/or group of users that is granted access to the document package. As an example of the forgoing, a workflow event could be assigned an initial value of “pending.” When an authorized user accesses the document package in order to execute a workflow event, the associated workflow event status indicator can be updated to a value of “in progress.” When the system receives an indication that the user has finished taking action with regard to the workflow event, the associated workflow event status indicator can be updated to the value of “completed.”

Based on one or more workflow events status indicators being set to a value of completed, electronic signature system 102 may determine one or more conditions on advancing the signing workflow are satisfied, and proceed in the sequence of the workflow. For example, logged workflow events may be used to advance the signing workflow, such as by storing and updating the associated status indicator values to track whether at least one condition on advancing the signing workflow is satisfied. In some cases, rather than requiring action from a particular user in the signing workflow to satisfy a condition, electronic signature system 102 may use at least one condition to advance the signing workflow that can be satisfied based on user group membership of an accessing user. For example, a workflow event from any member of a particular user group to cause a condition to be satisfied.

In some cases, after corresponding workflow events have been completed for contributors, electronic signature system 102 may provide the prepared document package to at least one signer of the signing workflow to allow a signer to electronically sign the documents in the document package. The electronic signature may be applied to the documents of the document package using a signer device 110, by way of example. While only one signer device is shown in FIG. 1A, it should be understood that any number of signers and associated signer devices can be employed. Optionally, upon conclusion of preparation by all of the one or more contributors that may be defined in the sequence of a signing workflow, the workflow dictates that the sequence returns to the originator. In particular, electronic signature system 102 can receive user input from the originator specifying approval of the prepared document package, with the approval being a condition that when satisfied advances the signing workflow to a signature collection phase (e.g., the documents are provided to a signer of the workflow).

As indicated above, electronic signature system 102 can be implemented using at least one server device, platform with corresponding application programming interfaces (APIs), cloud infrastructure, and the like. For example, the various communications or transmissions between client devices and electronic signature system 102 can use an API implemented by electronic signature system 102. In various implementations, electronic signature system 102 is accessed via one or more applications on the client devices. For example, each client device could contain a web browser or other application used to display a graphical user interface (GUI), optionally provided by electronic signature system 102, and to provide user input to the GUI to carry out various actions associated with the signing workflow and/or configuration thereof (e.g., assignments of permissions and users to the workflow, requests to add document to, remove documents from, and/or modify documents of the document package). These various requests and actions can be made via one or more network communications or other transmissions from the client devices containing API calls which correspond to those actions and requests.

FIG. 1B is a block diagram of an exemplary electronic signature system 102 in accordance with some embodiments of the invention. In the example shown, electronic signature system 102 includes various components, including but not limited to, workflow engine 114, document manager 116, permissions manager 118, authoring engine 120, rendering engine 121, signature engine 122, workflow auditor 124, and data store 170. FIG. 1B shows potential interchange channels for exchange of data between the various components of electronic signature system 102.

As an overview, workflow engine 114 is generally responsible for configuring and defining signing workflows, such as workflow 136. Workflow engine 114 also manages and tracks the status of workflows and workflow events thereof, as well as provides appropriate information pertaining to workflows to the various components of electronic signature system 102. Permissions manager 118 accesses permissions 152 from data store 170 pertaining to participants of signing workflows and provides this information, as needed, to the various components of electronic signature system 102 (e.g., in order to authorize various user requests and/or actions). Rendering engine 121 is responsible for rendering information pertaining to signing workflows for user interfaces, such as views for user interaction with document packages, including listings of documents, document metadata, and the like.

Document manager 116 manages documents and document packages, including assigning documents to document packages, adding documents to document packages, modifying documents of document packages, and providing documents of document packages and/or metadata thereof to other components of electronic signature system 102 (e.g., for viewing).

Authoring engine 120 is responsible for managing and facilitating document preparation during signing workflows. For example, authoring engine 120 can communicate with other components of electronic signature system 102 in order to authorize user requests and/or actions, to request information on behalf of other components of electronic signature system 102 for document preparation and management, and to provide that information to those components. Workflow auditor 124 is generally responsible for creating a record, or audit log, that captures various user actions and associated workflow events of workflows.

As indicated above, workflow engine 114 configures a signing workflow by defining and setting the parameters of the logical steps that the various services and components of electronic signature system 102 perform to carry out the workflow for a particular document package. These various configurations may be stored in data store 170. For example, workflow 136 may represent a workflow definition for a particular workflow for a particular document package 144. Workflow engine 114 may define workflow 136 using a set of workflow events 132 and conditions for satisfying those events. A workflow event can represent one or more particular actions to be executed as part of a workflow. The workflow event may specify that those particular actions are authorized for one or more specific users 128 and/or user groups. Workflow 136 may, in various implementations, be defined as a sequence of logical steps each comprising one or more workflow events and/or conditions for electronic signature system 102 to advance in the sequence to a subsequent step.

Workflow engine 114 can associate users 128 with workflow 136 as participants. Workflow engine 114 may also store this information for users 128 in user profiles in data store 170. A user profile may include identifying information of a user, such as a user login and/or password. Furthermore, a user profile may include contact information, such as a contact address or location of the user, which electronic signature system 102 can use to provide information to the user. As an example, a user profile could include an email address of the user, which electronic signature system 102 transmits messages to in order to facilitate workflow 136. For example, based on workflow engine 114 determining conditions for advancing in workflow 136 are satisfied, workflow engine 114 may cause electronic signature system 102 to email one or more participants based on the subsequent step of workflow 136 (e.g., based on identifying users associated with that step). As an example, workflow engine 114 may email or otherwise notify one or more users associated with a workflow event of the step in workflow 136.

As mentioned above, the workflow engine 114 additionally manages and tracks workflows, including distributing tasks of the workflow to the various services and components and provides the various services and components with data used to perform the assigned tasks. Upon initiating a step in a workflow, workflow engine 114 may assign workflow events of that step a status value of “pending.” Workflow engine 114 determines the actions associated with the workflow events are satisfied (e.g., based on conditions thereof), workflow engine 114 updates the status values for those workflow events. Conditions for advancing to a subsequent step of a workflow may include workflow engine 114 updating status values of one or more workflow events assigned to the step the workflow to “completed.”

When conditions for advancing in the workflow are satisfied, workflow engine 114 can trigger the step in the sequence and any system actions associated with that step. For example, workflow engine 114 may deliver instructions and information to one or more components associated with workflow events of the step in order to facilitate execution of those actions.

As mentioned above, the document manager 116 manages documents and document packages of signing workflows. This can include saving documents 140 and/or metadata thereof to data store 170, retrieving any of that information from data store 170, modifying any of that information in data store 170, as well as assigning particular documents with particular signing workflows and/or document packages. In some embodiments, the document manager 116 generates the document package and associates the document package with a signing workflow, such as document package 144 of signing workflow 136. Any document received by the electronic signature system 102 may be stored in data store 170 by the document manager 116. The document manager 116 can extract informational content and metadata, and parse form fields and text tags of the documents 140 to produce document data 148, and can store this information in data store 170 and/or provide that information to other components of the system.

As mentioned above, permissions manager 118 accesses permissions 152 from data store 170 pertaining to participants of signing workflows and provides this information, as needed, to the various components of electronic signature system 102 (e.g., in order to authorize various user requests and/or actions). These permissions can be determined for particular ones of users 128 accessing or attempting to access information of a particular signing workflow, such as document package 144 and user interfaces presented by rendering engine 121 to facilitate the signing workflow.

Using the various approaches described herein permissions manager 118 provides electronic signature system 102 with capabilities to secure and regulate particular actions and documents related to document preparation in signing workflows. As indicated in FIG. 1B, data store 170 includes permissions 152, which permissions manager 118 may associate with particular users. Examples of access rights specified by permissions 152 include rights to display or view documents, add or remove documents, edit/add/remove form fields or content of documents, and/or sign documents.

In some implementations, one or more of the associations between users and permissions are defined based on input received by electronic signature system 102 from an originator or other user of a signing workflow. For example, as mentioned above, electronic signature system 102 can assign one or more of these permissions to particular users (e.g., via input received from the originator via originator device 104). Workflow engine 114 may provide these assignments to permissions manager 118, which stores the assignments in data store 170 for retrieval and access during the signing workflow. For example, electronic signature system 102 can provide a user interface rendered using rendering engine 121 to receive input to configure the signing workflow including the permissions to assign. When permissions of particular users are needed during the signing workflow, such as to authorize actions or access to the document package by the users, permissions manager 118 accesses the stored assignments of permissions 152 to facilitate those determinations. In this way, electronic signature system can use the permissions associated with a user to control access to the document package 144.

In some cases, the permissions manager 118 maintains explicit assignments between the permissions 152 and users 128. In determining permissions 152 of a particular user, permissions manager 118 could retrieve any of the various permissions assigned to the user. Further, in some cases, the permissions manager 118 maintains assignments between users 128 and roles 156.

In determining permissions 152 of a particular user, permissions manager 118 could retrieve any of the various permissions associated with a role assigned to the user. For example, each role could include one or more default permissions, where a user assigned that role by default is assigned that permission. In various implementations, the originator, or other user can assign at least one permission to a user by selecting and/or assigning the role to the user (e.g., in a user interface). In some cases, this assignment is stored in data store 170, as described above. In other cases, based on this assignment, assignments of the associated permissions are explicitly stored without requiring a stored association with the particular role. In some cases, selecting a role for a user defines a subset of permissions from which the user can choose from to assign to particular users, where different roles may be associated with different subsets. Therefore, at least some permissions assigned to a user can be dictated by a role assigned to that user.

In addition to or instead of maintaining and accessing assignments of permissions 152 to users, in some embodiments, permissions manager 118 further maintains and accesses assignments between users and user groups. For example, any of the various authorizations and other system actions that are based on permissions could in addition or instead be based on which user group or groups are assigned to the associated user. A user group may refer to a grouping of users that is defined by a user, such as an originator. In some cases, in order for a user to be authorized for some action or request, that user must, in addition to being assigned the appropriate permission(s), also be assigned to the appropriate user group or groups. In doing so, user groups may be assigned to particular workflow events, logical steps of the workflow, and/or documents of the document package. For example, a user may have a permission to view documents of the document package, however, the system may deny authorization to view documents other than those provided by a member of a user group the user is a member of.

In addition or instead, user groups could be used to define conditions for advancing the signing workflow. As an example, in configuring the signing workflow, electronic signature system 102 could receive input from the originator assigning at least one user group to at least one workflow event. This assignment could specify that, for example, any member of an assigned user group may satisfy and be authorized for the corresponding workflow event (e.g., by performing an associated action). For example, the assignment could specify that each of Amy, Bob, and Charles are members of a user group. The assignment could further specify that for a workflow event comprising a user providing at least one document to the document package, any one of those users (or less than all of those users) may provide the at least one document to satisfy that workflow event (e.g., as long as that user has permissions to do so). Thus, if Bob adds a document to document package 144, electronic signature system 102 need not wait for action from Amy and Charles.

This approach can avoid stalling of the signing workflow, where electronic signature system 102 is stuck waiting for user action to advance the signing workflow. For example, with potentially large groups of users participating in preparing documents in the signing workflow, some users may be unavailable or otherwise unable or unwilling to access electronic signature system 102. Additionally, rather than the originator determining the exact users who should participate in workflow events or have access to particular documents, the originator can assign a user group, while still retaining an acceptable level of security by limiting actions to particular user groups.

Examples of roles 156 that can be associated with users 128 include an author role and a co-author role. An author may be predefined to include a subset of permissions 152 that enable a user to, for example, add documents to, remove documents from, and display or view documents of a document package (e.g., document package 144). A co-author may be predefined to include a subset of permissions 152 that enable a user to, for example, add documents to, remove documents from, edit form fields or content within documents of, and display or view documents of a document package.

Permissions may be applied to all documents 140 included within the document package 144, or may be restricted to particular documents or document types. In some cases, users having one role are restricted from accessing documents provided by another role, and/or edits to form fields or content modifications made by users assigned the other role. In addition or instead, similar restrictions could at least partially be enforced based on user groups, as described above.

As mentioned above, authoring engine 120 is responsible for managing and facilitating document preparation during signing workflows. Authoring engine 120 can, for example, facilitate authorizations of users and access by users regarding the document package 144 during workflow 136. As an example, a user (e.g., a contributor) may provide a request to electronic signature system 102 via a contributor device 106. In response to the request, authoring engine 120 can identify the content to be displayed for the user using rendering engine 121, and can control the user actions that can be performed (e.g., by authorizing requests, such as API calls provided by the user).

In some implementations, when a user request to view the document package 144 is received, workflow engine 114 provides the request to rendering engine 121. Rendering engine 121 uses authoring engine 120 to query permissions manager 118 for the set of permissions 152 assigned to the user, and optionally other information, such as user group membership information. The authoring engine 120 provides this information to document manager 116, which uses that information to determine which documents of the document package the user is authorized to access. Document manager 116 can generate document data 148 from those documents, and provide at least some of that information to authoring engine 120.

In some cases, this information includes a listing of the documents the user is authorized to access. For example, as shown, information from document manager 116 could include displayable documents list 160, which is a list of documents of the document package that can be displayed or otherwise accessed by the user.

Authoring engine 120 provides the information received from document manager 116 to rendering engine 121, which renders information in a user interface that is displayed to the user (e.g., on contributor device 106). This can include rendering engine 121 determining the electronic documents to populate in a composition page view. The composition page view can present the documents of displayable documents list 160 and may also indicate the permissible operations or user actions that may be taken on those documents based on the permissions, user groups, and other information provided by permissions manager 118.

For example, a composition page view can be provided to the user to access the document package 144. In some embodiments, the format and content of the composition page view depends on the role and/or user groups assigned to that user. For example, rendering engine 121 may render a composition page view based on a role assigned to the user, where the appearance and layout are different from a composition page view for a different role. In some embodiments, features corresponding to actions that are not authorized for the user may be displayed in a way to indicate those features are unavailable. For example, a feature may be associated with an icon and/or text in a GUI. Rendering engine 121 may render any of that information in grey to indicate the feature is not available to the user.

In some embodiments, rendering engine 121 generating or determining thumbnail images for each document of displayable documents list 160 for the user interface (e.g., composition page view). A “thumbnail” refers to a user interactive link which rendering engine 121 can render in the user interface as an image representative of a particular document. For example, a thumbnail for a document may be graphically depicted on the display of a computing device to resemble the cover page or other content of the electronic document to which it corresponds. A user that has access to the electronic signature system 102 may interact with a thumbnail to access the corresponding one of documents 140, or a particular page within an electronic document, represented by the thumbnail (e.g., to view or modify the document, or take other actions).

By receiving user inputs to the user interface rendered by rendering engine 121, the various user actions described herein can be carried out (e.g., via interactions with displayed representations of documents and/or the content thereof). The rendering engine 121 can interpret these inputs to produce document revision metadata 164, which captures the various user actions performed on the document package. The rendering engine 121 can submit the document revision metadata 164 to the authoring engine 120 to determine if the document revision metadata 164 corresponds to a permissible action (e.g., to authorize the captured actions). The authoring engine 120 can compare the received document revision metadata 164 against the permissions and user group and other information associated with the user.

The authoring engine 120 can use actions captured in the document revision metadata 164 that have been determined to be in compliance with the authorization information to generate updated document data 168. Unauthorized actions may be removed from document revision metadata 164. In this way, authoring engine 120 may act to verify the various actions performed with respect to the document package. The authoring engine 120 can deliver the updated document data 168 representing authorized user actions to the document manager 116 for incorporation with document data 148 and/or document package 144. This information can include indicators of user actions and identities of user and/or user groups responsible for those user actions. This information can be used to determine authorizations for future user actions and/or accesses to documents based on user group assignments and/or permissions.

In this way, the authoring engine 120 can evaluate the document revision metadata 164 for the document package 144 to enforce the operations or actions that can be executed for a particular user. As mentioned above, this can include whether electronic signature system 102 can display or view a document, remove a document, or add, edit, and/or remove form fields from a document (or otherwise modify the content of a document) for the user. Additionally, these actions can be accessed on a document-by-document basis, such that user actions for the user can be limited on appropriate portions of the document package.

Thus, the system may optionally employ two levels of security for preventing unauthorized user actions. First, rendering engine 121 may render an interface display which only permits actions authorized for a particular user. Second, authoring engine 120 may determine whether each action performed by the user was authorized. This approach can protect against authorized actions not received through the user interface, such as actions captured in API calls. This approach also allows for actions to be provided via user inputs to user interfaces not provided by rendering engine 121, or non-user interface based user inputs.

In various implementations, the authoring engine 120 can provide one or more workflow event status indicators 174 to the workflow engine 114 based on the user inputs and corresponding user actions. A workflow event status indicator 174 includes information about any workflow events captured by document revision metadata 164. For example, workflow event status indicator 174 could specify the status value of a particular workflow event as “completed.” In some implementations, the providing of the workflow event status indicator 174 to workflow engine 114 is based on the authoring engine 120 receiving an indication that a user session has been ended for the user (e.g., the user may select a save or apply button and/or provide a close session API call).

In response to receiving at least one workflow event status indicator 174, workflow engine 114 can determine whether the one or more conditions assigned to the logical step of the workflow 136 are satisfied. When satisfied, workflow engine 114 may advance workflow 136 to the next step and take any appropriate system actions associated with that step. For example, where the next step is for action from at least one contributor, similar actions may be taken as described above. Where the conditions are not satisfied, workflow engine 114 may determine that workflow 136 should remain at the current step. For example, in order to advance, it may be required by the conditions that at least one other contributor or other user take action on the document package 144 (e.g., a member of a different group, another member of the same group, or another particular user, or any user with a particular role).

Where the next step of the workflow includes a workflow event corresponding to a user signing one to all documents of the document package, the workflow engine 114 instructs the document manager 116 to deliver the document package to the signature engine 122. The signature engine 122 provides a signer access to review the prepared document package. In particular, after each step corresponding to a contributor within the signing workflow has been completed, workflow engine 114 may identify the document package as ready for signature.

In some implementations, the signature engine 122 provides an indication to the signer (e.g., via an email delivered to the signer device 110) that the document package is ready for signing. When the signer accesses the document package (e.g., via the email), the signature engine 122 provides the signer with the ability to affix a signature on documents of the document package. In this way, the signature engine 122 provides a means for affixing an indication of assent to the contractual terms set forth in the documents of the electronic document package. Typically, after all signers assigned to the signing workflow have provided a signature, the signing workflow may be completed.

As mentioned above, workflow auditor 124 is generally responsible for creating a record, or audit log, that captures various user actions and associated workflow events of workflows. Workflow auditor 124 may track document revision metadata 164 and/or updated document data 168 in relation to workflow events and corresponding user actions, such as by monitoring workflow event status indicators and generating a log to capture various events that occurred during the signing workflow. Each entry in the log could comprise a user and specify one or more user actions, along with a timestamp. In some cases, the log could indicate whether an action was authorized or unauthorized.

In conventional signing workflows, user actions related to document preparation are not tracked by the system, and therefore cannot be captured in an audit log. However, workflow auditor 124 can in some implementations capture these actions. For example, when user actions directed to a workflow event is received from a user, the workflow auditor 124 may track and store a list of document revisions for relevant documents, such as form fields or document content added, removed, or modified, document added to the document package, or documents removed from the document package during the workflow event. Each action could be associated with a time corresponding to when the user input to perform the associated action was received, and/or actions could be grouped into the same entry sharing a common time stamp. From this information, the workflow auditor 124 updates the audit log over time with corresponding entries.

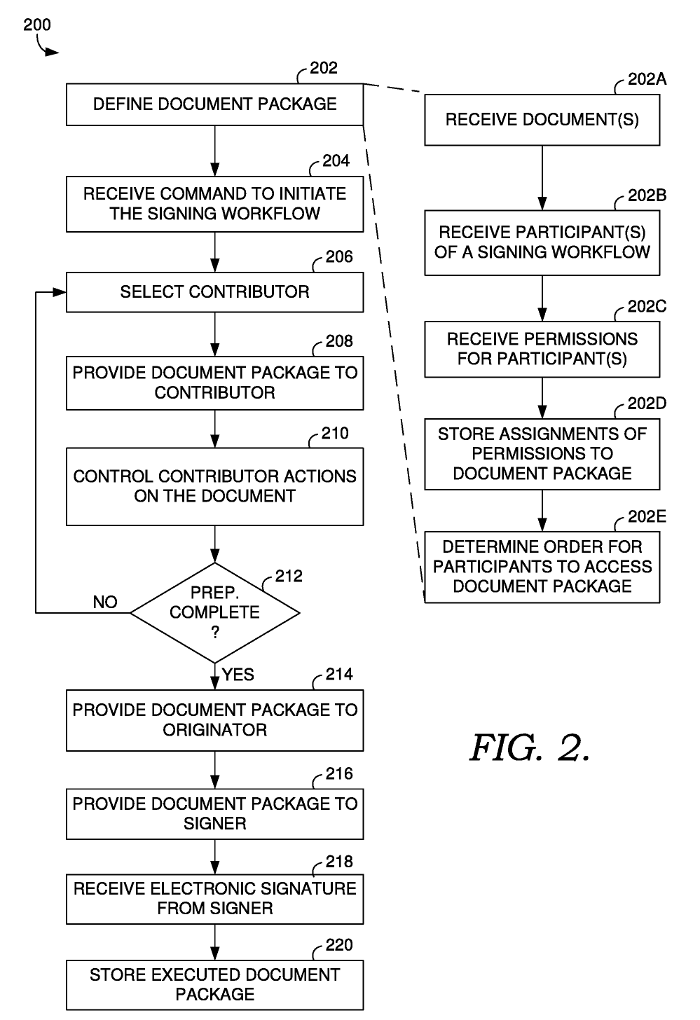

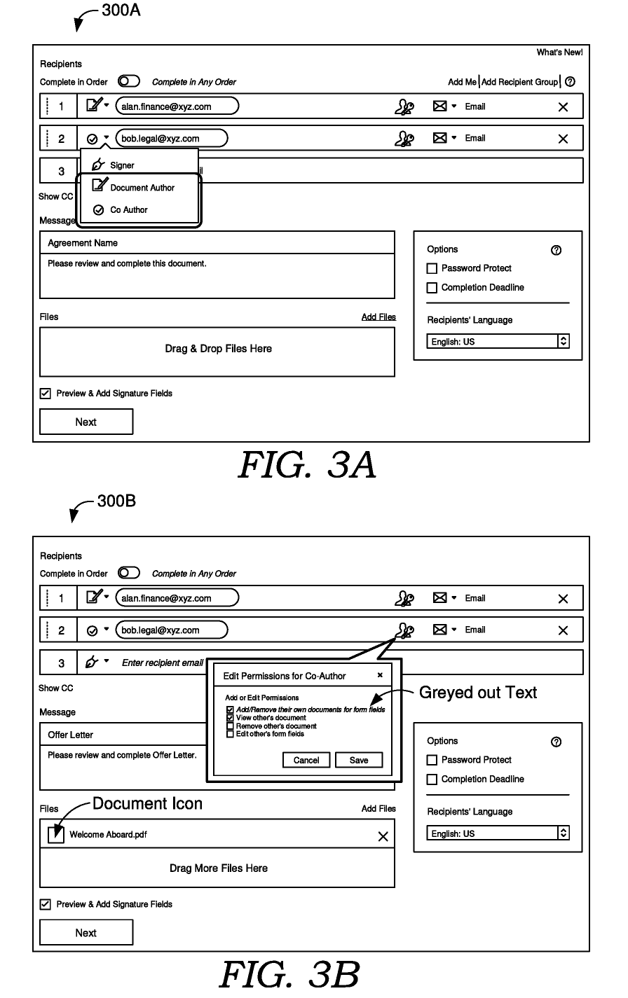

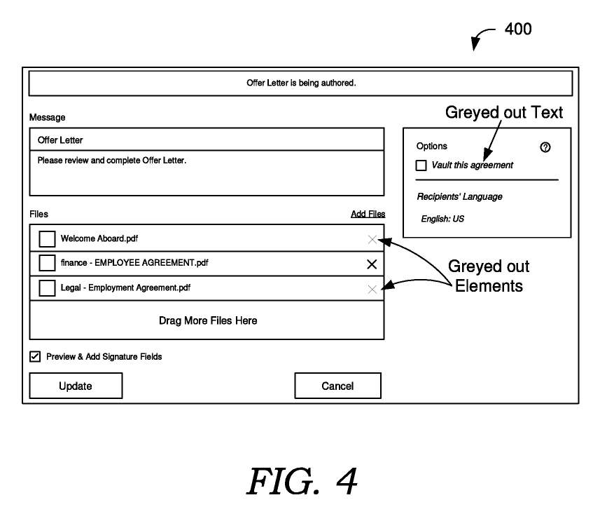

With reference now to FIG. 2, a flow diagram is provided that illustrates a method 200 for a signing workflow. To better illustrate method 200, FIGS. 3A, 3B, and 4 are provided as examples of views 300A, 300B, and 400, that may be rendered by rendering engine 121 of FIG. 1B during the workflow. This particular example includes generation of a document package through receiving a final signature of the document package from a computing device. Each block of method 200 and any other method discussed herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a server or hosted service (standalone or in combination with another hosted service), or a plug-in to another product, to name a few.

At block 202, the electronic signature system defines a document package and its associated information, such as assigned user, assigned permissions of those users, assigned user groups, assigned roles, optional sequencing information, and other configurable data that may be provided by an originator of the signing workflow. For example, the workflow engine 114 may define workflow 136 to capture this information.

The electronic signature system 102 can define the document package, for instance, in response to selections and/or assignments received via one or more UIs or APIs supported by the electronic signature system 102. Views 300A and 300B are examples of views in a user interface that may be employed to receive these user inputs.

Blocks 202A-202E illustrate exemplary processes that may be employed to define the document package. While block 202A describes receiving a document from a document originator, it is noted that in some embodiments, the electronic signature system 102 may define the document package without receiving of an initial document. In other embodiments, one or more electronic documents may be received, as shown at block 202A. If any electronic documents are provided, workflow engine 114 could provide them to the document manager 116, which assigns them to the document package 144.

To provide an example of block 202A, as shown, views 300A and 300B of FIGS. 3A and 3B each include an area 320 to which an originator can drag and drop files for inclusion into the document package. In addition or instead, the user could click on “Add Files” link 322 in FIG. 3A or FIG. 3B to browse for documents in a navigation window. View 300B shows that the user has added a document called “Welcome Aboard” to the list of documents to be added to the document package.

At block 202B, at least one participant for a signing workflow is received. For example, at least one of users 128 may be identified as a contributor, and at least one of users 128 may be identified as a signer. To provide an example of block 202B, in FIG. 3A, the view 300A includes a recipients area 324 in which the user has identified two users for the signing workflow using corresponding email addresses. It is noted, the number next to the user identifier may optionally indicate a sequence in which the user is to act on the document package in the signing workflow (e.g., they may define the ordering of steps in the workflow). In the example shown, a toggle option has been selected by the user indicating these users may act in any order (e.g., one step of the workflow may correspond to both users). While not shown, at least one signer may similarly be specified by the user for the workflow.

At block 202C, at least one permission is received for at least one participant. For example, the originator can specify one or more permissions for particular users. In some cases, this involves the user assigning specific contributor roles that are defined by the electronic signature system 102. For example, FIG. 3A shows the user assigning a “Co-Author” role to a user, which has at least one default permission defined in the system, which may include the irrevocable permission identified in the edit permissions window of FIG. 3B. As shown, based on the assignment of the role, the user can selectively assign one or more permissions associated with that role. As indicated, some of these permissions act to restrict access to the user to particular documents. Although not shown, various user group assignments could be accomplished in a similar manner. Furthermore, the other user identified in views 300A and 300B could be assigned permissions similar as the user assigned the “Co-Author” role. That user may be assigned, for example, the “Author,” or “Document Author” role, which has at least one different default permission.

At block 202D, the assignments of permissions are stored to the document package. For example, these assignments may be stored to data store 170. In some cases, the permissions manager 118 receives permission assignments from the workflow engine 114 and stores the sets of permission assignments for each user. In some cases, this includes storing assignments between users and roles. A signer may be given default permissions to view and sign the document package (e.g., once prepared). An “author” may be given default permissions to, for instance, add documents to the document package, remove documents from the document package, and display documents contained in the document package (e.g., during document preparation). A co-author may be given default permissions, for instance, similar to an “Author,” with additional permissions to add and remove form fields to documents within the document package.

At block 202E, an order for the users to access the document package during the signing workflow may optionally be determined, for instance, by the workflow engine 114. As indicated above, in some cases, the order can be at least partially automatically determined based on roles. For instance, each author may be given access, followed by each co-author, and finally each signer. Also as indicated above, the workflow engine 114 may receive user inputs specifying an order in which each user has access to the document package 144. This could include the originator changing a default order.

In some cases, order may be specified by user group. For example, the originator may specify that a legal team is to have access to the document package after a financial team. The originator can instruct the workflow engine 114 arrange the sequence of steps defining the workflow, such as by manipulating a list of users and/or user groups in a graphic user interface (GUI), or using an application program interface (API). As one example, in view 300A, the originator could move the second contributor to the top of the list by clicking the user's corresponding entry and dragging that entry to the top of the list. In this way, the steps of the signing workflow could be rearranged.

As indicated above, it is further contemplated that the originator may specify that more than one contributor could access the document package during the same step. Thus, for at least one step, two or more contributors may be granted access in parallel rather than in series (e.g., as a user group), such that a first contributor is not required to wait for another contributor to finish preparing documents before the other user can being. Therefore, steps of the signing workflow may be specified using any combination of serial and/or parallel user access steps to prepare the document package.

After the document package and corresponding signing workflow are defined, at block 204, the electronic signature system may receive a command to initiate the electronic signing workflow. For example, after the originator finishes identifying each user and other information for the signing workflow and document package, the user may select a GUI element to provide the command. For example, the user could select a “Send” button in the user interface, which could be similar to the “Next” button 326 in view 300B of FIG. 3B.

At block 206, the workflow engine 114 selects at least one user profile based on the order defined by the workflow for the document package. Each selected user profile is provided access to the document package 144, at block 208. This could include, the electronic signature system 102 providing an email with a hyperlink to a selected contributor to facilitate the access to the document package.

At block 210, the electronic signature system controls contributor actions on the document package. This can include enforcing the various permissions and user groups assigned the users in order to render views of user interfaces and/or authorize user actions received by the system, as has been described above. One or more workflow event status indicators may be updated according to the user actions.

An example of a view 400 in a user interface that rendering engine 210 could render to facilitate document preparation by a contributor is shown in FIG. 4. In view 400, similar to views 300A and 300B, the user may drag and drop or otherwise provide documents to add to the document package. Based on the user selecting, for example, the “Update” button 426, the system may optionally verify the modification to authorize the user actions taken on the document package. In some cases the listing of documents shown could include documents the user is authorized to view and/or modify (e.g., remove). This listing could correspond to displayable documents list 160. As another example, a different listing could be used for those documents, which may be provided in a different view than shown. In the example shown, the “Welcome Aboard” document 428 is from displayable documents list 160, although a corresponding GUI element is greyed out to indicate the user does not have permissions to remove this document which was added by a different user.

At block 212, the workflow engine 114 may determine whether each condition associated the preparation of documents for the document package has been satisfied. If not, at least one other contributor may be selected (e.g., for the next step of the workflow), as shown by the return to block 206. This could repeat any number of times, as directed by the workflow definition.

When the workflow engine 114 determines each condition associated the preparation of documents for the document package has been satisfied at block 212, the electronic signature system 102 may optionally require an affirmative indication from the originator or other authorized user that the documents are to be provided to the signer(s) of the signing workflow for signature. For example, the electronic signature system 102 may receive user input from the user to an icon, button, or other GUI element in a user interface, where that input corresponds to the affirmative indication. By selecting the GUI element, the user causes the workflow engine 114 to provide the documents of the document package to at least one signer for signature, as indicated at block 216.

In this way, the signing workflow may permit the originator an opportunity to provide a final review of the prepared document package 144. In some embodiments, the originator may have permissions to display, edit, and/or remove any of the electronic documents in the document package 144. In other embodiments, permissions could be limited. For example, the authoring engine 120 and/or rendering engine 121 may prevent the originator from displaying or viewing one or more documents, which may contain sensitive information in the content of the document and/or a form field of the document (e.g., description of an employee compensation package in an employment contract). Further, the originator could be permitted to view documents, but not modify those documents.

In providing the finalized document package 144 to a signer at block 216, the electronic signature system 102 may, for example, automatically prepare and send an email to an address associated with a signer, including a hyperlink to access the document package for signature. The rendering engine 121 can render a view in a user interface that allows the signer to review all of the electronic documents in the document package that are relevant to that signer for signature. Using that interface, the signer may optionally provide an electronic signature to those documents which is processed by the signature engine 122, as at block 218.

In some embodiments, the document manager 116 may combine individual documents of the document package to generate a single combined document for the signer to sign. Also, in some embodiments, the document manager 116 may also convert form fields into plain text and/or flattened document content.

In some embodiments, a signature step of the signing workflow may include multiple workflow events where a signer provides a virtual signature to multiple fields and to multiple documents within the document package 144 before the document package can be determined by the workflow engine 114 as considered fully executed. Document manager 116 can store the executed document package in data store 170, as shown at block 220.

As indicated above, in some embodiments, the workflow auditor 124 can generate an audit trail based on the various user inputs received during method 200. The audit trail can capture the history of the document package as it is being prepared and signed. This audit trail may include a list of document revision metadata and one or more corresponding time stamps based on when the user inputs occurred.

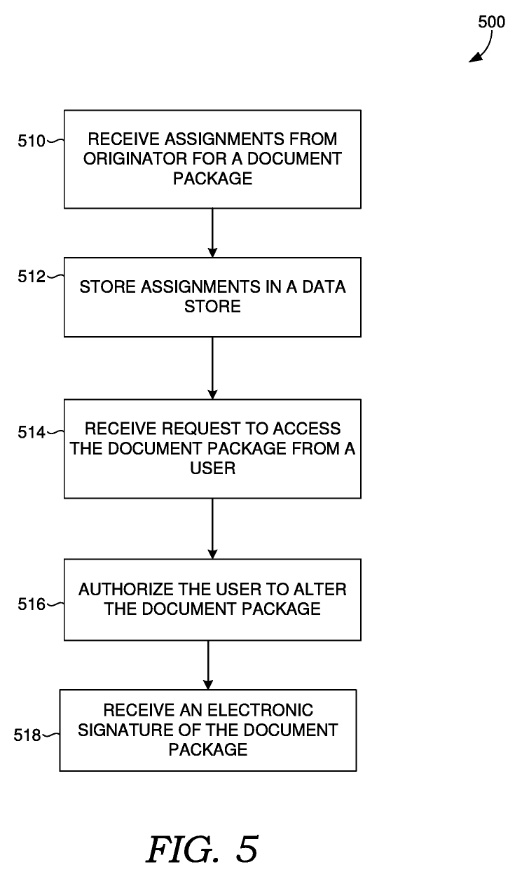

With reference now to FIG. 5, a flow diagram is provided that illustrates a method 500 for a signing workflow. At block 510, the process includes receiving assignments from an originator for a document package. For example, an assignment of a permission to a non-signer user of a signing workflow can be received from an originator of the signing workflow. The permission can enable the non-signer user to alter a set of documents of a document package during the signing workflow.

At block 512, the process includes storing the assignments in a data store. For example, the permission assigned to the non-signer user can be stored in a permissions data store.

At block 514, the process includes receiving a request to access the document package from a user. For example, a request from the non-signer user can be received where the request is to access the set of contract documents in the signing workflow.

At block 516, the process includes authoring the user to alter the document package. For example, based on the received request, the non-signer user can be authorized to apply an alteration to the document package that adds a document to or removes a document from the set of documents using the permission accessed from the permissions data store.

At block 518, the process includes receiving an electronic signature of the document package. For example, an electronic signature of the document package comprising the alteration can be received from a signer.

Having described embodiments of the present invention, an exemplary operating environment in which embodiments of the present invention may be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions, such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) port(s) 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O port(s) 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present invention are generally directed to an electronic document system that provides an electronic signing workflow in which multiple document contributors can participate in generating and editing a document package for electronic signature. The present invention has been described in relation to particular embodiments, which are intended in all respects to be illustrative rather than restrictive. Alternative embodiments will become apparent to those of ordinary skill in the art to which the present invention pertains without departing from its scope.

The subject matter of the present invention has been described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present and future technologies.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A computer-implemented method for managing signing workflows, the method comprising:
receiving, from an originator of a signing workflow, an assignment of a permission to a non-signer user of the signing workflow, the permission enabling the non-signer user to alter a set of documents of a document package during the signing workflow;
storing, in a permissions data store, the permission assigned to the non-signer user;
receiving a request from the non-signer user to access the set of contract documents in the signing workflow;
based on the received request, authorizing the non-signer user to apply an alteration to the document package that adds a document to or removes a document from the set of documents using the permission accessed from the permissions data store; and
receiving, from a signer, an electronic signature of the document package comprising the alteration.

2. A method of claim 1, wherein the assignment of the permission comprises user input indicating the originator assigning a role to the non-signer user, and wherein the permission is associated with the assigned role.

3. A method of claim 1, wherein the alteration comprises removing the document from the set of documents, and the authorizing comprises:
accessing a stored indicator of an identify of a user that provided the document to the document package; and
determining the permission grants the non-signer user a right to alter the document based on the accessed stored indicator of the identify.

4. A method of claim 1, comprising receiving, from a client device associated with the non-signer user, at least one document to add to the set of document for the alteration, wherein the authorizing comprises:
determining the permission grants the non-signer user a right to add the received at least one document to the set of documents; and
based on the determining, adding the at least one document to the set of documents of the document package.

5. A method of claim 1, wherein based on the permission accessed from the permissions data store, the non-signer user is restricted from removing at least one document from the set of documents, and the method further comprises:
receiving, from the originator, an assignment of a different permission to a different non-signer user of the signing workflow, the different permission enabling the different non-signer user to alter the set of documents during the signing workflow; and
based on a received request from the different non-signer user in the signing workflow, authorizing the different non-signer user to remove the document from the set of documents using the different permission accessed from the permissions data store.

6. A method of claim 1, further comprising based on the received request, authorizing the non-signer user to view at least one document of the document package using a different permission accessed from the permissions data store, the different permission enabling the non-signer user to view documents that were added to the document package by other users.

7. A method of claim 1, further comprising based on the received request, restricting the non-signer user from viewing at least one document of the document package based on an access of the permissions data store indicating the non-signer user lacks a different permission that would enable the non-signer user to view documents that were added to the document package by other users.

8. A method of claim 1, further comprising based on the received request:
accessing, from the permissions data store, a set of permissions assigned to the non-signer user by the originator;
determining a subset of documents in the document package that the non-signer user is authorized to view as dictated by the accessed set of permissions; and
rendering a view of the document package in a user interface, the view displaying the determined subset of documents that the non-signer user is authorized to view.

9. A method of claim 1, wherein the permission enables the non-signer user to alter documents that were added to the document package by the non-signer user, but not documents that were added to the document package by another user.

10. A method of claim 1, further comprising:
receiving, from the originator, an assignment of the non-signer user to a group of users, wherein the signing workflow includes a condition on advancing the signing workflow that can be satisfied by any one of the users in the group accessing the document package; and
providing the document package to the signer for the electronic signature based on determining the condition is satisfied.

11. A method of claim 1, further comprising adding the document to the document package based on the authorizing, wherein the document package does not include any documents prior to the document being added.

12. At least one non-transitory computer-readable media having executable instructions embodied thereon, which, when executed by at least one processor, causes the at least one processor to perform a method for managing signing workflows, the method comprising:
storing in a permissions data store, an assignment by a user of a set of permissions to a non-signer user of a signing workflow, the set of permissions enabling the non-signer user to alter a set of documents of a document package during the signing workflow;
based on a request received from the non-signer user in the signing workflow, determining an access right of the non-signer user with respect to at least one document in the set of documents using the set of permissions from the permission data store;
rendering a view of the document package in a user interface, wherein based on the determined access right, the rendered view enables user input corresponding to an alteration to the document package that adds a document to or removes a document from the set of documents; and
receiving, from a signer, an electronic signature of the document package comprising the alteration.

13. A computer-readable media of claim 12, wherein the assignment of the set of permissions comprises user input indicating the originator assigning a role to the non-signer user, and wherein at least one of the permissions is associated with the assigned role.

14. A computer-readable media of claim 12, comprising receiving the user input, the user input defining at least one document to add to the set of document for the alteration, and the method further comprises in response to receiving the user input:
determining the set of permissions grants the non-signer user a right to add the at least one document to the set of documents; and
based on the determining, adding the at least one document to the set of documents of the document package.

15. A computer-readable media of claim 12, wherein the view indicates a subset of documents in the document package that the non-signer user is permitted to view, based on the set of permissions accessed in the permissions data store.

16. A computer-implemented system for managing signing workflows, the system comprising:
a workflow engine to receive an assignment of a permission to a non-signer user of a signing workflow, the permission enabling the non-signer user to alter a set of documents of a document package during the signing workflow;
a permissions manager to store, in the permissions data store, the permission assigned to the non-signer user and access the stored permission;
an authoring engine to authorize the non-signer user to apply an alteration to the document package that adds a document to or remove a document from the set of documents using the permission accessed from the permissions data store by the permissions manager; and
a signature engine to receive, from a signer, an electronic signature of the document package comprising the alteration.

17. The computer-implemented system of claim 16, further comprising:
a document manager to:
receive, from the permissions manager, a set of permissions assigned to the non-signer user in the permissions data store; and
determine a subset of documents in the document package that the non-signer user is authorized to view based on the received set of permissions; and
a rendering engine to:
receive an indicator of the subset of documents; and
render a view of the document package in a user interface, the view displaying the subset of documents based on the received indicator.

18. The computer-implemented system of claim 16, further comprising a signature engine to provide the document package to the signer for the electronic signature based on determining a condition on advancing the signing workflow is satisfied, wherein the condition can be satisfied by any one user in a group of users accessing the document package.

19. The computer-implemented system of claim 16, wherein the authoring engine authorizing the non-signer user to apply the alteration includes:
accessing a stored indicator of an identify of a user that provided the document to the document package; and
determining the permission grants the non-signer user a right to alter the document based on the accessed stored indicator of the identify.

20. The computer-implemented system of claim 16, further comprising a workflow auditor to record, as an entry in an audit log of the signing workflow, a description of the alteration to the document package in association with the non-signer user and a timestamp.
